(19) United States
(12) Patent Application Publication
(10) Pub. No.: US 2012/0181492 A1
(43) Pub. Date: Jul. 19, 2012

(54) Horizontal anchor windlass for boats

(76) Inventor: Robert Matos, Clearwater, FL (US)

(21) Appl. No.: 12/930,821

(22) Filed: Jan. 18, 2011

(51) Int. Cl. B66D 1/72; B66D 1/14; B66D 1/12

(52) U.S. Cl. 254/323

(57) ABSTRACT

A windlass for a boat has an electric motor and drive gears mounted to a base. A chainwheel is mounted on a shaft extending through a divider plate. The chainwheel has a first portion and an opposite second portion joined for rotation in unison, and forming an annular groove adapted to engage an anchor rode. First and second clutch disks frictionally engage the chainwheel to transmit torque. A nut threaded onto the shaft end retains the clutch disks and the chainwheel on the shaft. The nut allows selective adjustment of the frictional engagement of the clutch. A stripper plate helps to transmit pulling forces from the rode to the base, reducing radial forces on the shaft, and also serves to strip the rode from engagement with the chainwheel.

First and second arcuate members having first and second opposed, coextensive, arcuate grooves are mounted on the divider plate. A retainer is disposed across the chainwheel annular groove, for pressing the rode into the chainwheel annular groove, to retain the rode on the chainwheel. The retainer has upper and lower trunnions that slide in the first and second arcuate grooves toward the slack portion of the rode. A leaf spring will bias the retainer against the rode. A funnel directs the rode downward into the boat.

### CROSS-REFERENCE TO RELATED APPLICATIONS

Reference is hereby made to utility patent application titled, “Anchor Windlass For Boats;” filed by Robert Matos, of Sunrise, Fla., on Feb. 16, 2010, Ser. No. 12/658,850. The prior application is expressly incorporated herein by reference.

### STATEMENT REGARDING FEDERALLY SPONSORED RESEARCH OR DEVELOPMENT

Not Applicable

### BACKGROUND OF THE INVENTION

This invention relates to the field of winches, and more particularly to a windlass for raising and lowering a boat anchor.

A typical boat anchoring system includes a rode, which is a rope connected to a chain. The rode is attached to the anchor. A windlass pulls the rode to raise the anchor, and pays out the rode to lower the anchor. A typical windlass has a chainwheel, which is a sheave configured to grip both the rope and the chain. A pressure finger pivots at one end and is spring loaded against the rode. The pressure finger keeps the rode from slipping off the chainwheel. However, the pressure finger does a poor job of retaining the rode on the chainwheel. The pressure finger abrades the rope, and often allows the rope or chain to climb out of the chainwheel, fouling or jamming or damaging the rode. The rode can impact the tensioning mechanism and damage the swivel pin, which is used to guide the rode into the anchor chain locker. Conventional windlasses can allow the rode to drag across the ocean floor, becoming abraded and swollen. The rode is then no longer uniform in size and surface texture, and can run off the chainwheel or break, resulting in injury to a crewmember. The rode winding around an open or partly enclosed chainwheel can trap and injure fingers, hands, and feet.

Accordingly, there is a need to provide an anchor windlass for boats that can guide the rode surely and consistently onto the chainwheel, and prevent the rode from climbing or slipping off the chainwheel.

There is a further need to provide an anchor windlass of the type described and that will not damage, abrade, or break the rode.

There is a yet further need to provide an anchor windlass of the type described and that will safely haul the anchor without endangering the crew.

There is a still further need to provide an anchor windlass of the type described and that will guide the rode into the chain locker without fouling.

There is another need to provide an anchor windlass of the type described and that can be manufactured cost-effectively in large quantities of high quality.

### BRIEF SUMMARY OF THE INVENTION

In accordance with the present invention, there is provided a windlass 20 for use in connection with a boat and an anchor (not shown), and a rode 22. A base 24 has a motor mounting hole 40. The base bottom surface 36 is adapted for attachment to the boat. The base 24 has a divider plate 42 extending upward from the top surface. A shaft 50 is mounted to the base 24 for rotation and extends through the divider plate.

A chainwheel 58 is mounted on the shaft 50 for rotation therewith. The chainwheel 58 has an outer periphery 60 and an annular groove 62 adapted to engage the rode 22.

A first arcuate member 64 is mounted on the divider plate. The first arcuate member 64 has an arcuate first groove 74 facing outward and extending along the first arcuate member 64 from a proximate end 70 to a distal end 72.

A second arcuate member 76 is mounted on the first arcuate member. The second arcuate member 76 has an arcuate second groove 86 facing inward and extending along the second arcuate member 76 from a proximal end 82 to a distal end 84. The second groove 86 faces and is coextensive with the first groove 74.

A retainer 88 is disposed across the chainwheel annular groove 62, for pressing the rode 22 into the chainwheel annular groove 62, so as to retain the rode 22 on the chainwheel 58. The retainer 88 has an upper trunnion 98 and a lower trunnion 104. The upper and lower trunnion left ends, 102 and 108 respectively, are received in the first groove 74. The upper and lower trunnion right ends, 100 and 106 respectively, are received in the second groove 86. This allows the trunnions 98 and 104 to pivot in the first 74 and second 86 grooves as the retainer 88 flexes, and to slide in the first 74 and second 86 grooves toward the slack portion of the rode 22, so as to conform closely to the rode 22, during rotation of the chainwheel 58 in either direction. The retainer has corrugations 118 for contact with the rode 22. A leaf spring 120 is mounted coextensively on the retainer 88, and is used for biasing the retainer 88 against the rode 22. A cover 126 is adapted to cover the rode 22.

Drive means, such as an electric motor 132, is provided for rotatively driving the shaft 50. A worm 136, worm gear 138, pinion 140, and bull gear 142, transmit rotary power from the motor 132 to the shaft 50, while providing the proper reduction ratio. A housing 143 covers the drive gears and base top.

A funnel 144 is mounted on the base for directing the rode 22 downward into the boat. The funnel has a mouth facing upward, and a nozzle extending downward.

The chainwheel 58 has a first portion 150 and an opposite second portion 152. The first 150 and second 152 portions are joined for rotation in unison. A sleeve 154 is disposed between the chainwheel first 150 and second 152 portions.

A first clutch disk 156 frictionally engages the chainwheel first portion 150. A second clutch disk 158 frictionally engages the chainwheel second portion 152, so as to transmit torque from the shaft 20 to the chainwheel 58.

A nut 160 is threaded onto the shaft end. The nut 160 retains the clutch disks 156, 158 and the chainwheel 58 on the shaft 50. The nut 160 allows selective adjustment of the frictional engagement of the clutch disks 156 and 158 with the chainwheel first 150 and second 152 portions respectively.

A stripper plate 166 helps to transmit pulling forces from the rode 22 to the base 24, reducing radial forces on the shaft 50, and also serves to strip the rode 22 from engagement with the chainwheel 58. A freefall mechanism 171 allows the rode 22 to exit the windlass 20 in freefall by the weight of the anchor and rode.

### BRIEF DESCRIPTION OF THE SEVERAL VIEWS OF THE DRAWING

As mounted for use in a boat, the front aspect of the windlass faces aft, the rear aspect of the windlass faces forward, the right side of the windlass faces to starboard, and the left side of the windlass faces to port. A more complete understanding of the present invention may be obtained from consideration of the following description in conjunction with the drawing, in which:

FIG. 1 is a perspective view of a windlass constructed in accordance with the invention.

FIG. 2 is an exploded assembly perspective view of the windlass of FIG. 1.

FIG. 3 is a top plan sectional view of the windlass of FIG. 1, taken along lines 3-3 of FIG. 1.

FIG. 4 is a front perspective view of the windlass of FIG. 1, with the housing, cover, and chainwheel outer portion removed.

FIG. 5 is a front perspective view of the base of the windlass of FIG. 1.

FIG. 6 is a top plan view of the base of FIG. 5.

FIG. 7 is a sectional view of the base of FIG. 5, taken along lines 7-7 of FIG. 6.

FIG. 8 is a rear inside perspective view of the cover of the windlass of FIG. 1.

FIG. 9 is a front inside perspective view of the housing of the windlass of FIG. 1.

FIG. 10 is a front perspective view of the funnel of the windlass of FIG. 1, taken along lines 10-10 of FIG. 11.

FIG. 11 is a top plan view of the funnel of FIG. 10.

FIG. 12 is a side elevational sectional view of the funnel of FIG. 10, taken along lines 12-12 of FIG. 11.

FIG. 13 is an exploded assembly perspective view of the nut and trigger of the windlass of FIG. 1.

FIG. 14 is a bottom perspective view of the nut of FIG. 13.

FIG. 15 is a rear perspective view of the stripper plate of the windlass of FIG. 1.

FIG. 16 is a side elevational view of the stripper plate of FIG. 15.

FIG. 17 is a top plan view of the stripper plate of FIG. 15.

FIG. 18 is a rear elevational view of the stripper plate of FIG. 15.

FIG. 19 is a rear perspective view of the gear drive train of the windlass of FIG. 1.

FIG. 20 is a side elevational view of the clutch disk of the windlass of FIG. 1.

FIG. 21 is a front elevational view of the clutch disk of FIG. 20.

FIG. 22 is a right side elevational view of the inner chainwheel of the windlass of FIG. 1.

FIG. 23 is a top plan view of the chainwheel of FIG. 22.

FIG. 24 is a top sectional plan view of the chainwheel of FIG. 22, taken along lines 24-24 of FIG. 22.

FIG. 25 is a left side elevational view of the inner chainwheel of FIG. 22.

FIG. 26 is a left side elevational view of the outer chainwheel of the windlass of FIG. 1.

FIG. 27 is a top plan view of the chainwheel of FIG. 26.

FIG. 28 is a top sectional plan view of the chainwheel of FIG. 26, taken along lines 28-28 of FIG. 26.

FIG. 29 is a right side elevational view of the chainwheel of FIG. 26.

FIG. 30 is a front assembly perspective view of the inner and outer arcuate members and the retainer of the windlass of FIG. 1.

FIG. 31 is an exploded front assembly perspective view of the inner and outer arcuate members and the retainer of FIG. 30.

FIG. 32 is a front perspective view of the retainer of FIG. 30.

FIG. 33 is a rear perspective view of the retainer of FIG. 30.

FIG. 34 is a sectional view of the retainer of FIG. 30, taken along lines 34-34 of FIG. 33, and showing the leaf spring installed in the retainer.

FIG. 35 is a sectional view of the retainer of FIG. 30, taken along lines 34-34 of FIG. 33, and showing the leaf spring ready to install in the retainer.

FIG. 36 is a front view of the leaf spring.

FIG. 37 is a left side elevational view of the outer arcuate member of FIG. 30.

FIG. 38 is a bottom plan view of the outer arcuate member of FIG. 37.

FIG. 39 is a partial, sectional view of the outer arcuate member of FIG. 37, taken along lines 39-39 of FIG. 37.

FIG. 40 is a right side elevational view of the inner arcuate member of FIG. 30.

FIG. 41 is a bottom plan view of the inner arcuate member of FIG. 40.

FIG. 42 is a partial, sectional view of the inner arcuate member of FIG. 40, taken along lines 42-42 of FIG. 40.

FIG. 43 is a right side elevational view of the windlass of FIG. 1, with the cover, the nut, and the chainwheel outer portion removed, showing the retainer and the anchor chain winding out.

FIG. 44 is a right side elevational view of the windlass of FIG. 1, with the cover, the nut, and the chainwheel outer portion removed, showing the retainer and the anchor chain winding in.

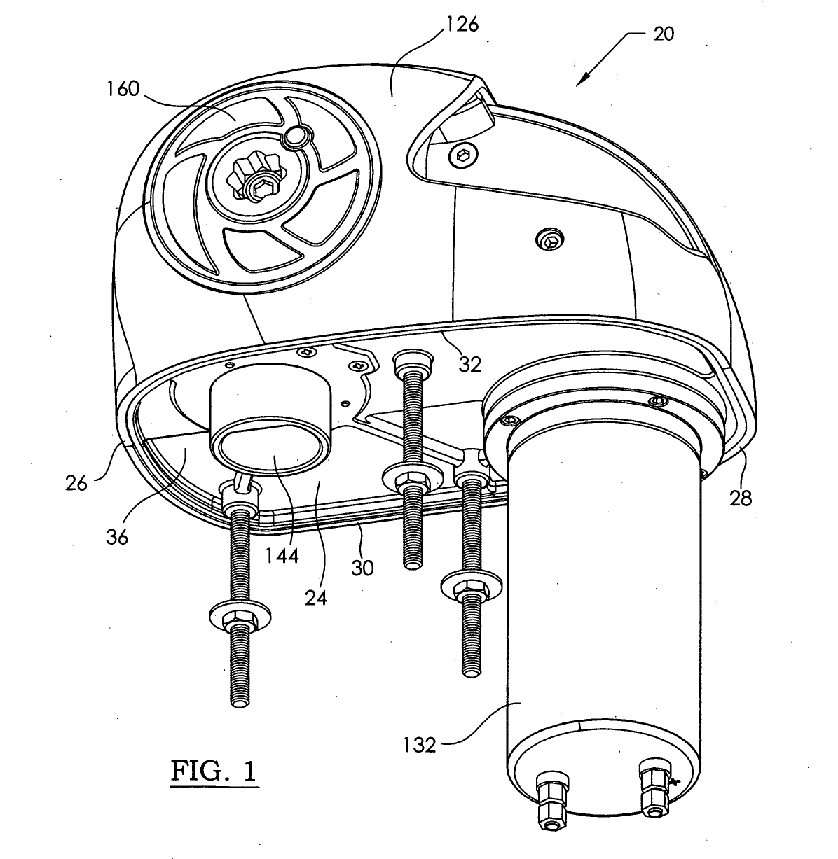

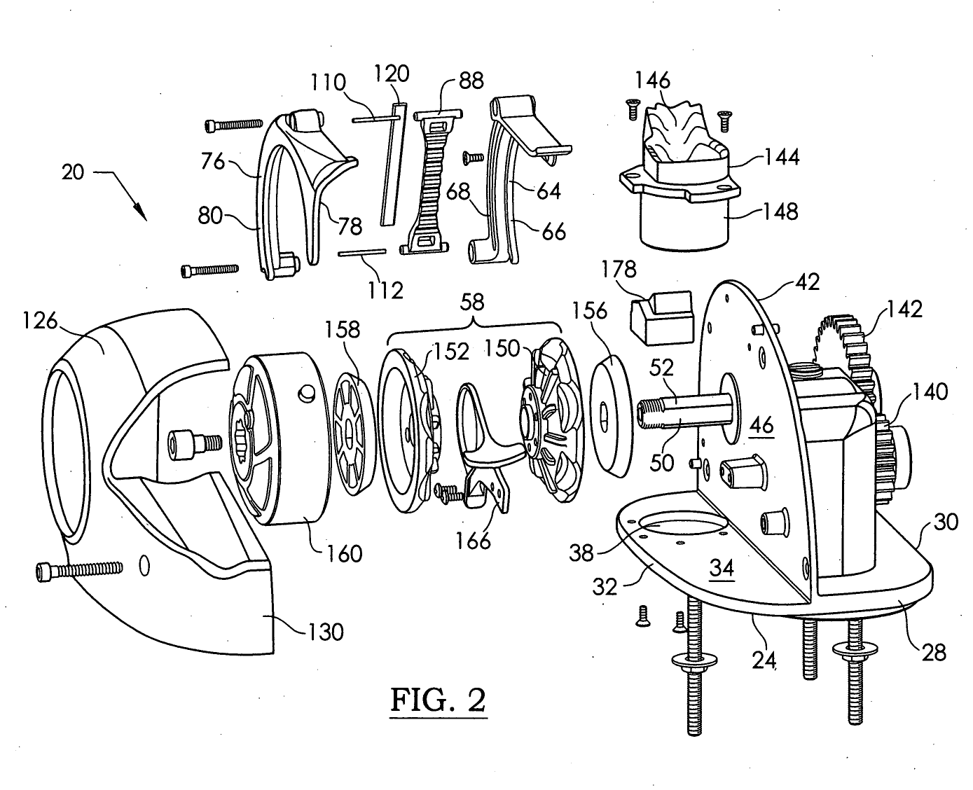

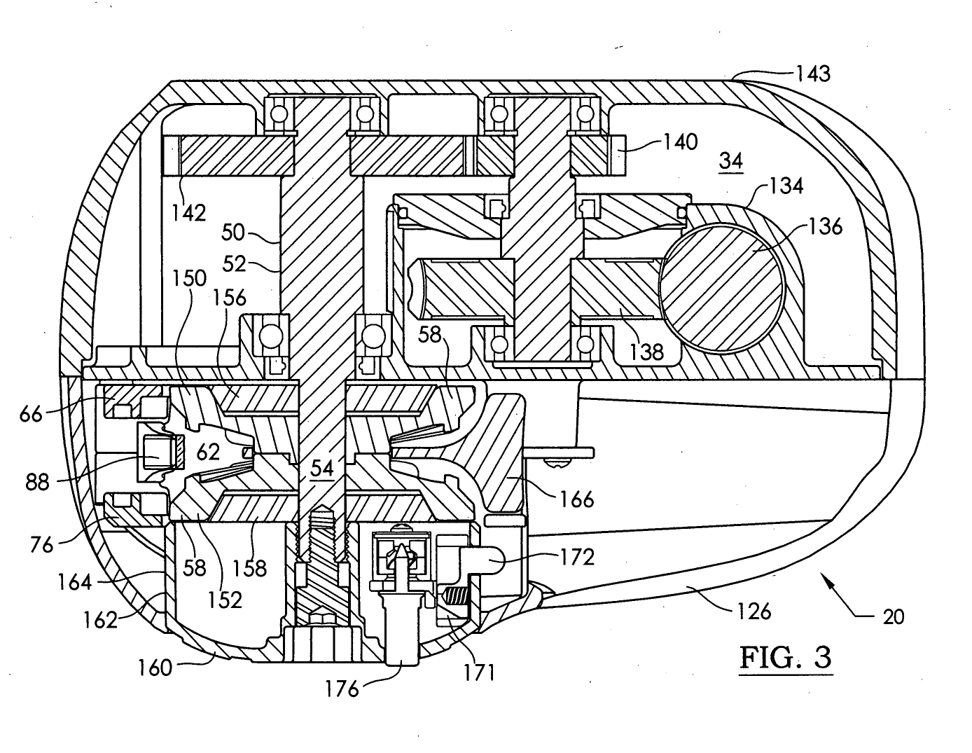

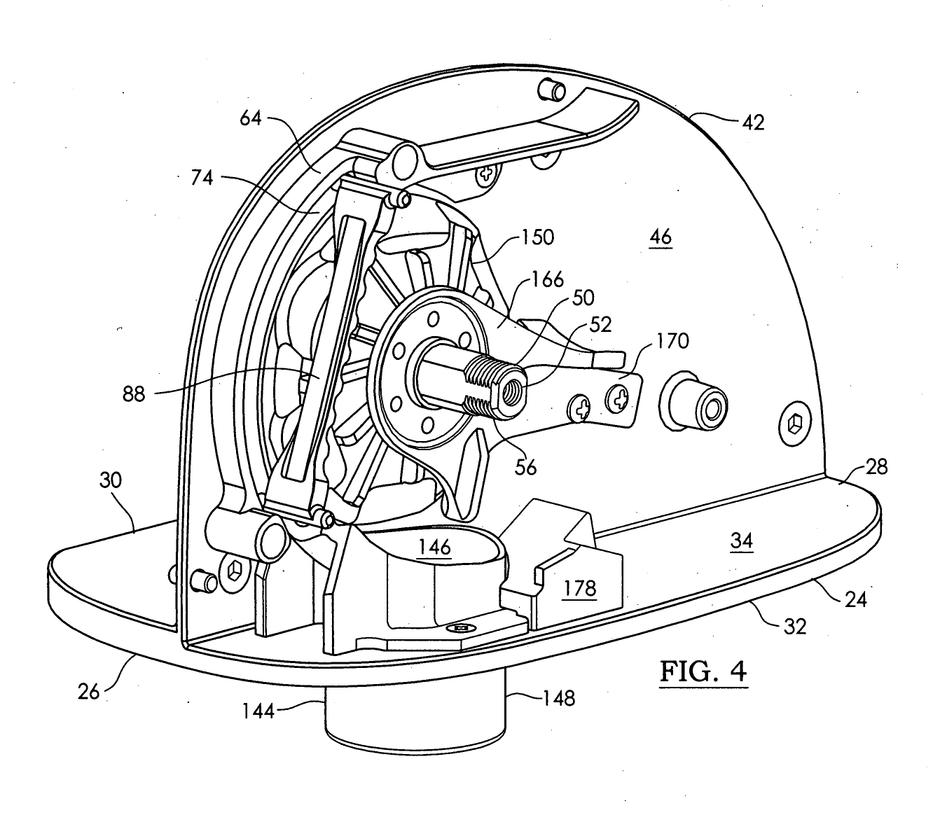

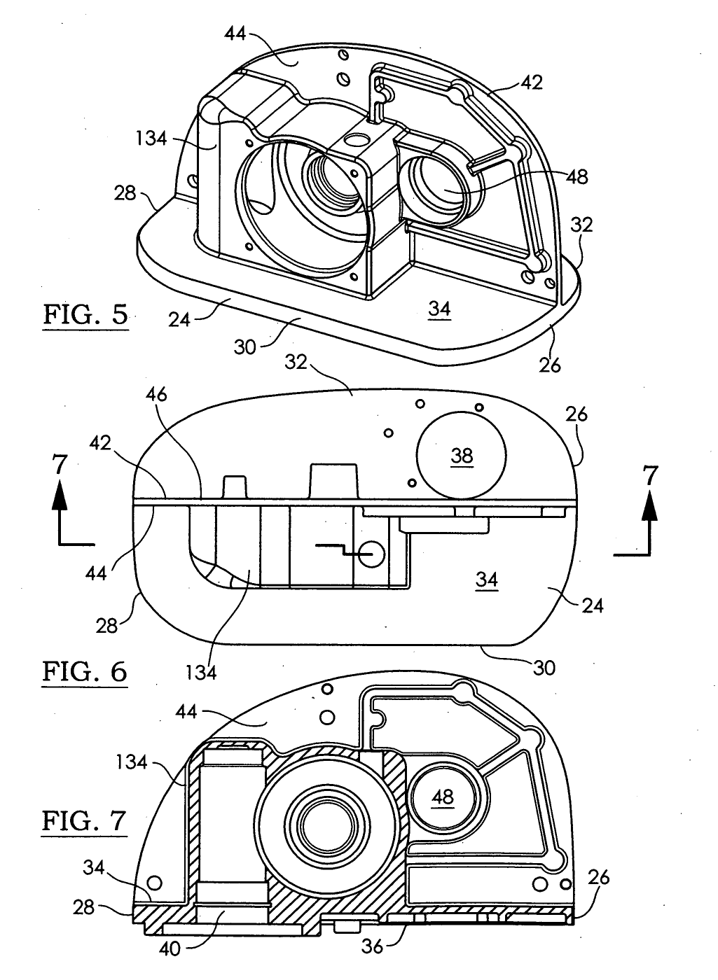

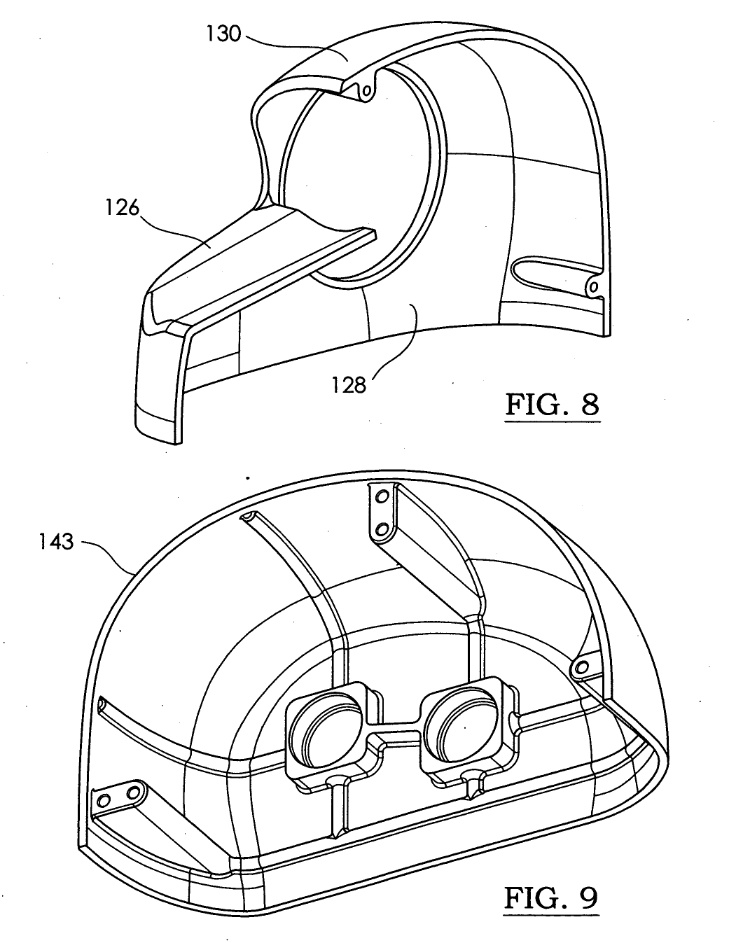

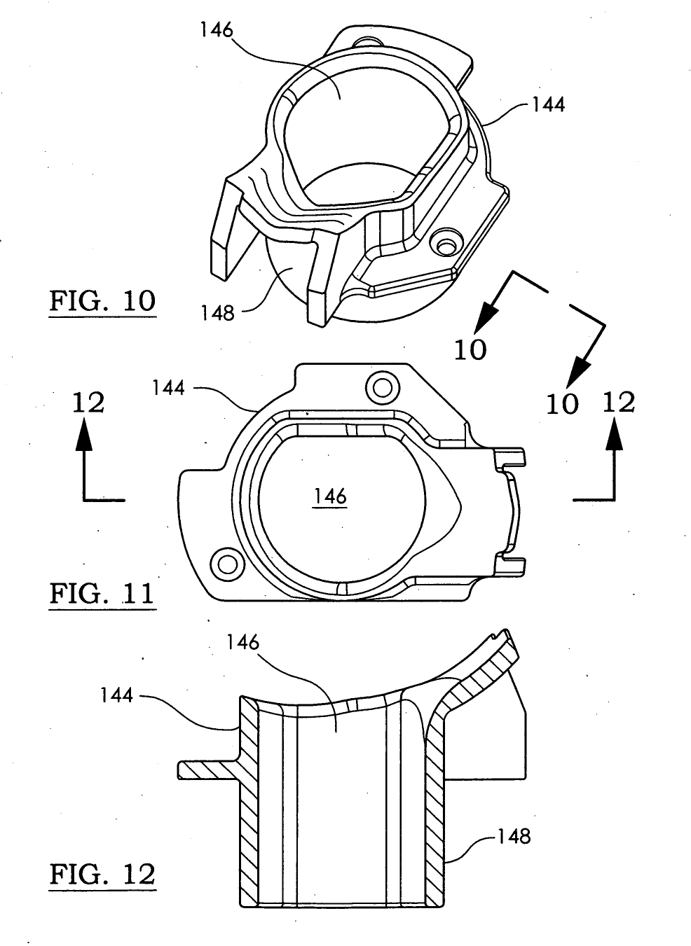

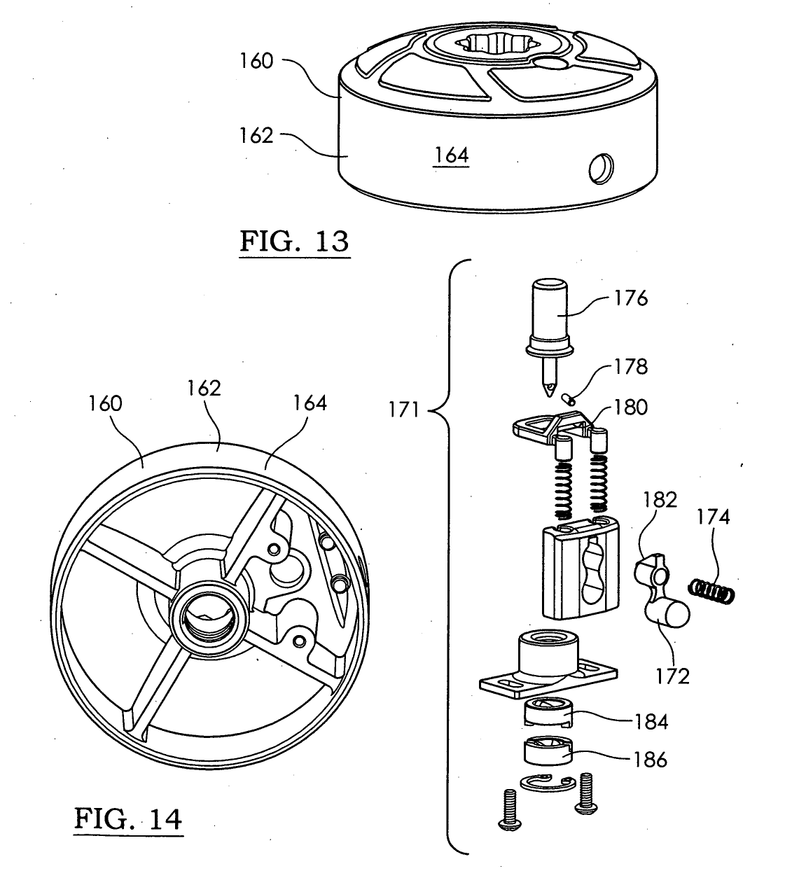

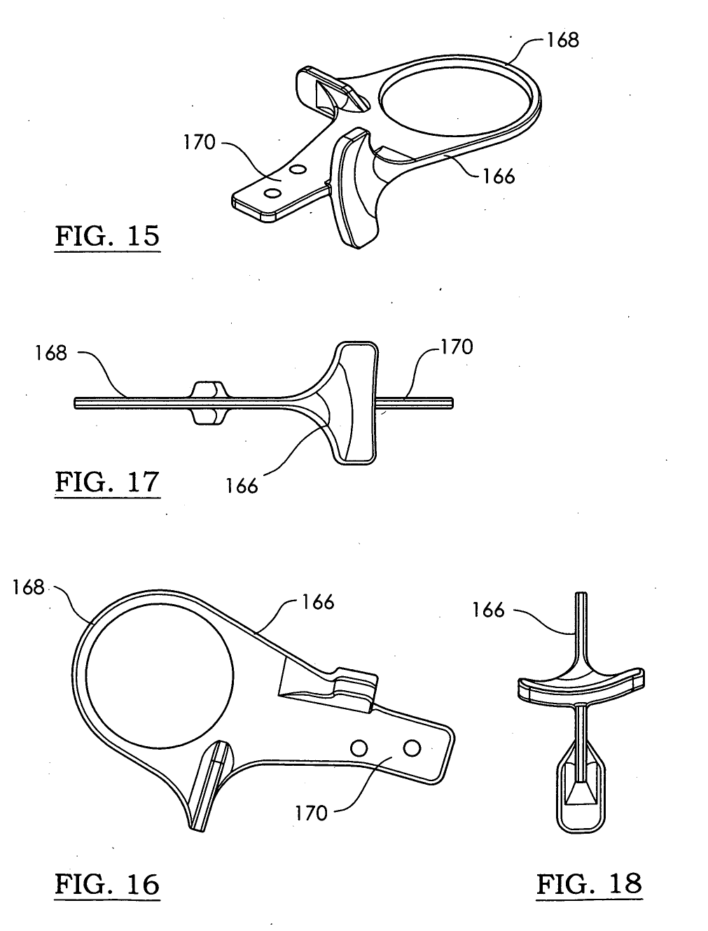

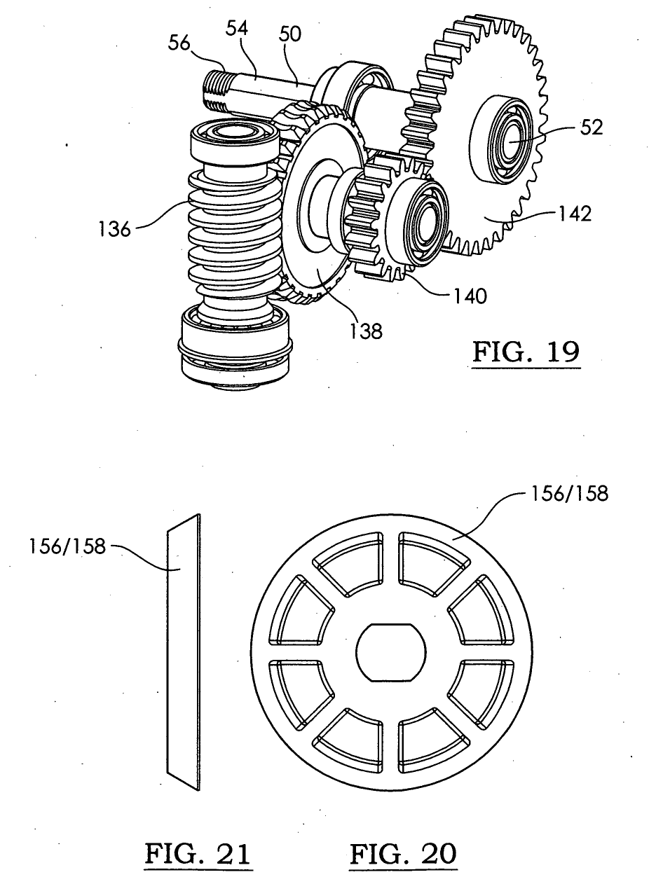

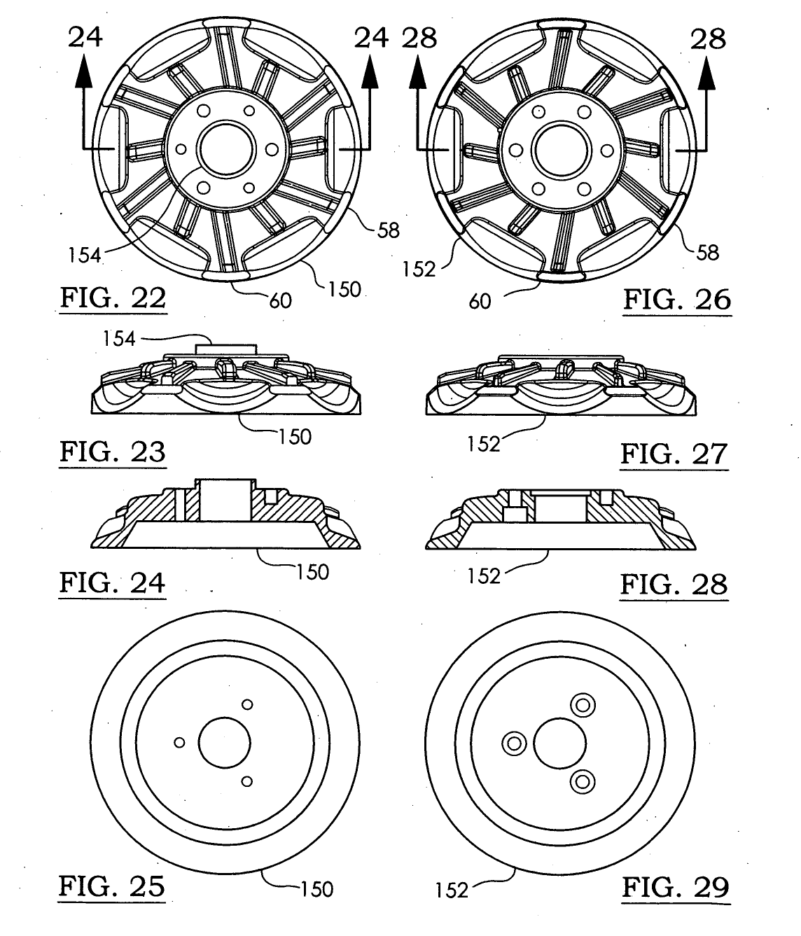

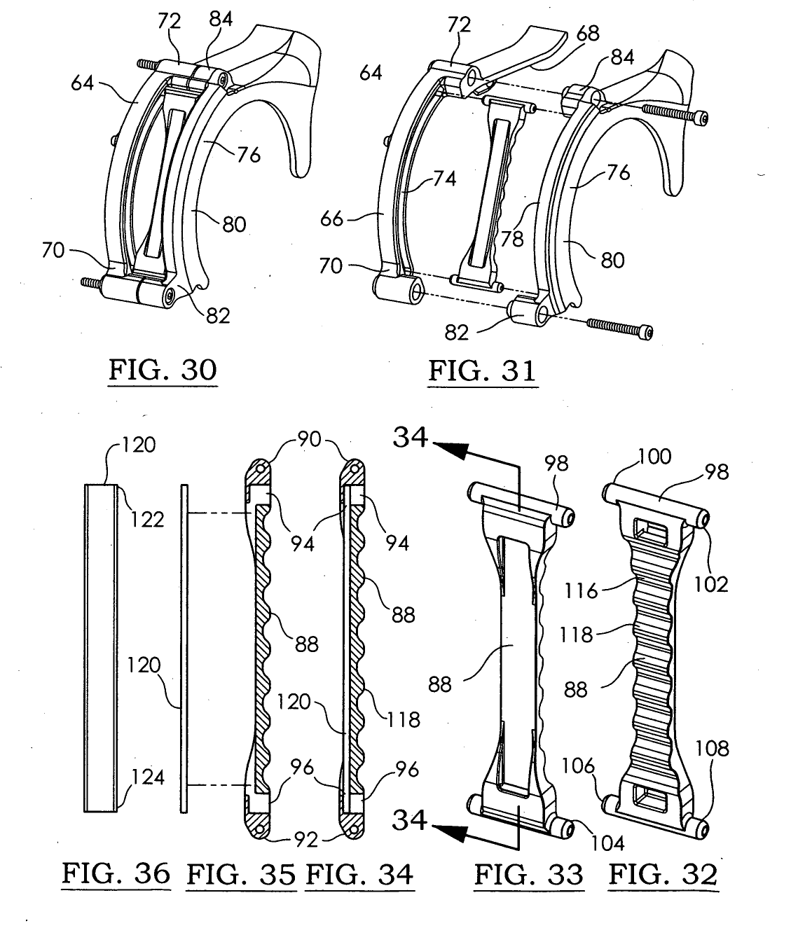

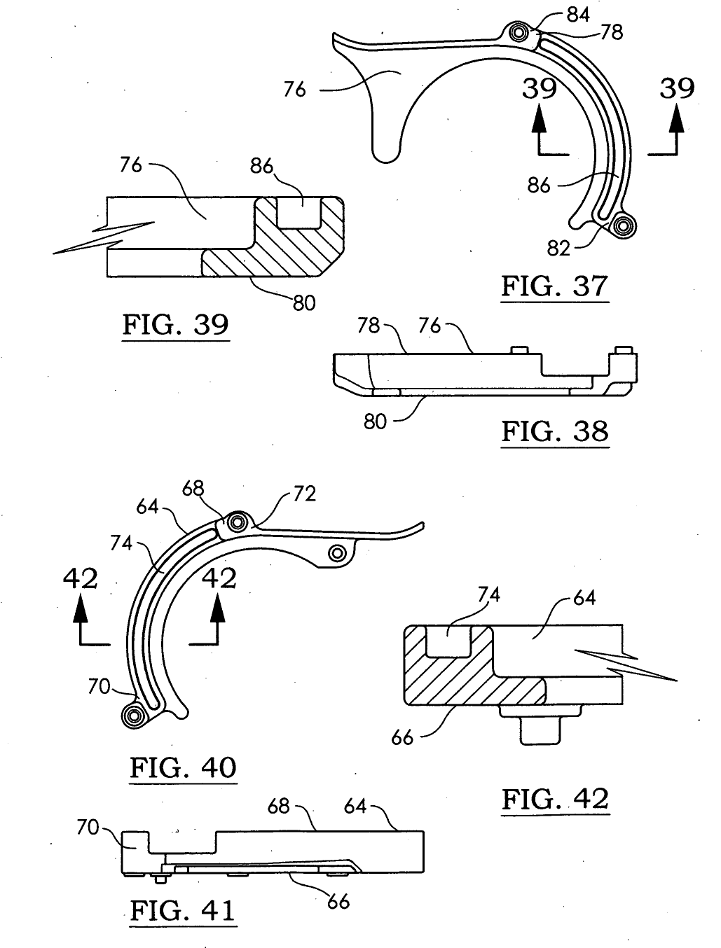

### DETAILED DESCRIPTION OF THE INVENTION

Referring now to the drawing, a windlass is shown at 20 and is for use in connection with a boat and an anchor (not shown), and a rode 22. The windlass is adapted for selective powered raising and lowering of the anchor. The rode 22 has a tensioned portion entering the windlass as the anchor is hauled up, and a slack portion exiting the windlass into the chain locker. The tensioned and slack portions can reverse as the windlass direction reverses.

A base 24 extends between opposite front 26 and rear 28 ends, and between opposite left 30 and right 32 sides, and between opposite top 34 and bottom 36 surfaces. The base 24 has at least one aperture 38 from the top 34 through to the bottom 36. The base 24 has a motor mounting hole 40 from the top 34 through to the bottom 36. The base bottom surface 36 is adapted for attachment to the boat. The base 24 has a divider plate 42 extending between the base front 26 and rear 28 ends, and extending upward from the base top surface 34. The divider plate 42 has a drive side 44 and an opposite chainwheel side 46. The divider plate 42 has a transverse hole 48 therethrough.

A shaft 50 extends between opposite drive 52 and chainwheel 54 ends. The shaft 50 is mounted to the base 24 for rotation and extends through the divider plate transverse hole 48. The shaft 50 has threads 56 on the chainwheel end 54.

A chainwheel 58 is mounted on the shaft 50 for rotation therewith. The chainwheel 58 has an outer periphery 60 and an annular groove 62 around the outer periphery 60. The chainwheel annular groove 62 is adapted to engage the rode 22 so as to pull the rode 22 during rotation of the chainwheel 58.

A first arcuate member 64 has opposite inner 66 and outer 68 sides. The first arcuate member inner side 66 is mounted on the divider plate chainwheel side 46. The first arcuate member outer side 68 faces away from the divider plate 42. The first arcuate member 64 extends from a proximal end 70 adjacent the base front end 26 and top surface 34 upward to a distal end 72. The first arcuate member 64 has an arcuate first groove 74 facing outward and extending along the first arcuate member 64 from the proximate end 70 to the distal end 72.

A second arcuate member 76 has opposite inner 78 and outer 80 sides. The second arcuate member inner side 78 is mounted on the first arcuate member outer side 68. The second arcuate member 76 extends from a proximal 82 end adjacent the base front end 26 and top surface 34 upward to a distal end 84. The second arcuate member 76 has an arcuate second groove 86 facing inward and extending along the second arcuate member 76 from the proximal end 82 to the distal end 84. The second groove 86 faces and is coextensive with the first groove 74.

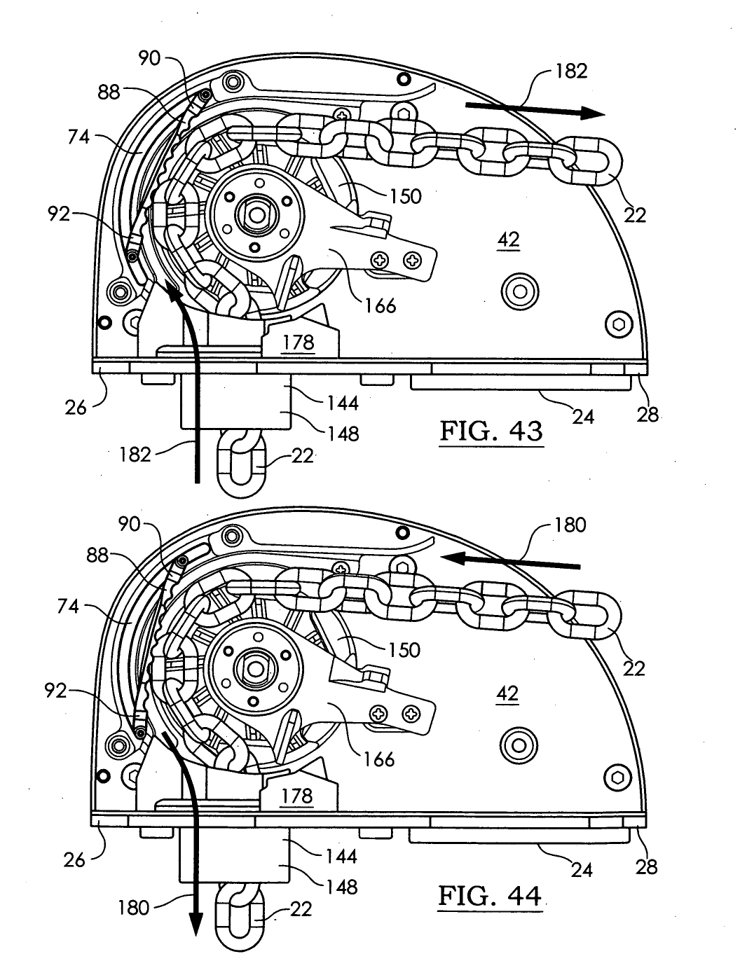

A retainer 88 extends between opposite upper 90 and lower 92 ends. The retainer 88 has an upper pocket 94 adjacent the upper end 90 and a lower pocket 96 adjacent the lower end 92. The retainer 88 is flexible, and is disposed across the chainwheel annular groove 62, for pressing the rode 22 into the chainwheel annular groove 62, so as to retain the rode 22 on the chainwheel 58. The retainer 88 has an upper trunnion 98 on the retainer upper end 90. The upper trunnion 98 extends between opposite right 100 and left 102 ends. The retainer 88 has a lower trunnion 104 on the retainer lower end 92. The lower trunnion 104 extends between opposite right 106 and left 108 ends. An upper pin 110 extends transversely through the upper trunnion 98 and a lower pin 112 extends transversely through the lower trunnion 104 to strengthen the trunnions. The upper and lower trunnion left ends, 102 and 108 respectively, are received in the first groove 74. The upper and lower trunnion right ends, 100 and 106 respectively, are received in the second groove 86. This allows the trunnions 98 and 104 to pivot in the first 74 and second 86 grooves as the retainer 88 flexes, and to slide in the first 74 and second 86 grooves toward the slack portion of the rode 22, as shown in FIGS. 43 and 44. In this manner, the retainer 88 will conform closely to the rode 22, especially toward the slack portion, during rotation of the chainwheel 58 in either direction. The retainer 88 has a front surface 114 and an opposite rear surface 116. The retainer rear surface 116 has corrugations 118 for contact with the rode 22. The rode 22 brushing across the corrugations 118 will cause the retainer 88 to slide upwardly and downwardly in the first 74 and second 86 grooves toward the slack portion of the rode 22, which tends to ride off the chainwheel. This will ensure that the rode 22 is retained on the chainwheel 58, and will not ride up and out of the chainwheel 58 regardless of slack in the rode. FIG. 44 shows the anchor rode 22 being hauled in to hoist the anchor, as indicated by arrows 190. The retainer 88 slides downward, and is in contact with the slack portion of the rode 22. FIG. 43 shows the anchor rode 22 being let out to drop the anchor, as indicated by arrows 192. The retainer 88 slides upward, and is again in contact with the slack portion of the rode 22.

A leaf spring 120 extends between opposite upper 122 and lower 124 ends. The leaf spring 120 is mounted coextensively on the retainer 88, and is used for biasing the retainer 88 against the rode 22. The leaf spring upper end 122 is received in the upper pocket 94. The leaf spring lower end 124 is received in the lower pocket 96. The pockets hold the leaf spring 120 closely adjacent the retainer front surface 114, while allowing the leaf spring 120 to flex with the retainer 88.

A cover 126 extends between the base front 26 and rear 28 ends on the chainwheel side 46 of the divider plate 42. The cover 126 has inner 128 and outer 130 surfaces. The cover 126 is attached to the base 24 and covering the chainwheel 58, shaft chainwheel end 54, and retainer 88. The cover 126 is adapted to cover the rode 22.

Drive means is provided for rotatively driving the shaft 50. Specifically, the drive means comprises an electric motor 132 mounted beneath the base 24 and aligned with the motor mounting hole 40. The base 24 has an integral gearcase 134 juxtaposed with the motor mounting hole 40. A worm 136 and worm gear 138 set is mounted in the gearcase 134 and attached to the motor 132. A spur gear set, including a pinion 140 and a bull gear 142 is mounted between the worm gear set 136, 138 and the shaft drive end 52. The gears will transmit rotary power from the motor 132 to the shaft 50, while providing the proper reduction ratio, which is well known in the art. A housing 143 covers the drive gears and base top surface 34 on the divider plate drive side 44.

A funnel 144 is mounted on the base aperture 38 for directing the rode 22 downward into the boat. The funnel 144 has a mouth 146 facing upward, and a nozzle 148 extending downward and communicating with the mouth 146.

The chainwheel 58 has a first portion 150 and an opposite second portion 152. The first 150 and second 152 portions are joined for rotation in unison. A sleeve 154 is disposed between the chainwheel first 150 and second 152 portions. The sleeve 154 is concentric with the shaft 50.

A first clutch disk 156 is mounted on the shaft 50 and keyed for rotation therewith. The first clutch disk 156 frictionally engages the chainwheel first portion 150 so as to transmit torque from the shaft 20 to the chainwheel 58.

A second clutch disk 158 is mounted on the shaft 50 and keyed for rotation therewith. The second clutch disk 158 frictionally engages the chainwheel second portion 152 so as to transmit torque from the shaft 20 to the chainwheel 58.

A nut 160 is mounted for rotation with the shaft 50 and is threaded onto the shaft threads 56 on the shaft chainwheel end 54. The nut 160 has a periphery 162 and a rim 164 around the periphery 162. The nut 160 retains the clutch disks 156, 158 and the chainwheel 58 on the shaft 50. The nut 160 allows selective adjustment of the frictional engagement of the clutch disks 156 and 158 with the chainwheel first 150 and second 152 portions respectively. This allows engagement and disengagement as well as slippage of the clutch disks 156 and 158, thereby precluding breakage of the rode should the anchor become stuck and tension increases.

A stripper plate 166 has a proximal end 168 encircling the annular groove 62 between the chainwheel first 150 and second 152 portions. The stripper plate 166 extends rearward to a distal end 170 which is attached to the base 24. The stripper plate 166 helps to transmit pulling forces from the rode 22 through the chainwheel 58, through the stripper plate 166 to the base 24. This reduces radial forces on the shaft 50, when the boat is anchored in high wind. The stripper plate 166 also serves to strip the rode 22 from engagement with the chainwheel 58.

A freefall mechanism 171 includes a stop pin 172 mounted inside the nut 160. The stop pin 172 is able to slide between a retracted position within the nut rim 64 and an extended position extending outward beyond the nut rim 64. This allows the stop pin 172 to follow a predetermined rotational path as the nut turns. A spring 174 is juxtaposed with the stop pin 172 for biasing the stop pin into the extended position. A release button 176 is mounted inside the nut 160 and projects outside the nut for manually depressing and thus selectively releasing the stop pin 172 for movement into the extended position. A stop block 188 is mounted on the base 24 and is disposed in the rotational path of the stop pin 172. First and second indexing collars 184 and 186 respectively, are disposed below the release button 176. An index pin 178 is attached to the release button 176. The index pin 178 cooperates with helical ramps inside the indexing collars 184 and 186 to rotate and hold the release button 176. A bevel bracket 180 slides along a beveled surface 182 of the stop pin 172, moving the stop pin 172 into the extended position. Thus, upon powered lowering of the anchor, the release button 176 will be activated, and the stop pin 172 will move into the extended position. The stop pin 172 will strike the stop block 188, thereby causing rotation of the nut 160 to stop. Continuing rotation of the shaft 50 will cause the nut 160 to move axially outward on the shaft threads 56, thereby releasing engagement of the clutch disks 156 and 158 from the chainwheel 58, and allowing the rode 22 to exit the windlass 20 in freefall by the weight of the anchor and rode. The freefall mechanism 171 is known in the art, and is adapted for the present invention.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

PARTS LIST
HORIZONTAL ANCHOR WINDLASS FOR BOATS

| PART | |
|---|---|
| NO. | DESCRIPTION |
| 20 | windlass |
| 22 | rode |
| 24 | base |
| 26 | base front end |
| 28 | base rear end |
| 30 | base left side |
| 32 | base right side |
| 34 | base top surface |
| 36 | base bottom surface |
| 38 | aperture |
| 40 | motor mounting hole |
| 42 | divider plate |
| 44 | divider plate drive side |
| 46 | divider plate chainwheel side |
| 48 | divider plate transverse hole |
| 50 | shaft |
| 52 | shaft drive end |
| 54 | shaft chainwheel end |
| 56 | shaft threads |
| 58 | chainwheel |
| 60 | chainwheel outer periphery |
| 62 | chainwheel annular groove |
| 64 | first arcuate member |
| 66 | first arcuate member inner side |
| 68 | first arcuate member outer side |
| 70 | proximal end |
| 72 | distal end |
| 74 | arcuate first groove |
| 76 | second arcuate member |
| 78 | inner side |
| 80 | outer side |
| 82 | proximal end |
| 84 | distal end |
| 86 | arcuate second groove |
| 88 | retainer |
| 90 | retainer upper end |
| 92 | retainer lower end |
| 94 | retainer upper pocket |
| 96 | retainer lower pocket |
| 98 | upper trunnion |
| 100 | upper trunnion right end |
| 102 | upper trunnion left end |
| 104 | lower trunnion |
| 106 | lower trunnion right end |
| 108 | lower trunnion left end |
| 110 | upper pin |
| 112 | lower pin |
| 114 | retainer front surface |
| 116 | retainer rear surface |
| 118 | corrugations |
| 120 | leaf spring |
| 122 | upper end |
| 124 | lower end |
| 126 | cover |
| 128 | inner surface |
| 130 | outer surface |
| 132 | motor |
| 134 | gearcase |
| 136 | worm |
| 138 | worm gear |
| 140 | pinion |
| 142 | bull gear |
| 143 | housing |
| 144 | funnel |
| 146 | mouth |
| 148 | nozzle |
| 150 | chainwheel first portion |
| 152 | chainwheel second portion |
| 154 | sleeve |
| 156 | first clutch disk |
| 158 | second clutch disk |
| 160 | nut |
| 162 | nut periphery |
| 164 | nut rim |
| 166 | stripper plate |
| 168 | stripper plate proximal end |
| 170 | stripper plate distal end |
| 171 | freefall mechanism |
| 172 | stop pin |
| 174 | spring |
| 176 | release button |
| 178 | index pin |
| 180 | bevel bracket |
| 182 | stop pin beveled surface |
| 184 | first indexing collar |
| 186 | second indexing collar |
| 188 | stop block |
| 190 | hoist arrows |
| 192 | drop arrows |

The embodiments of the invention in which an exclusive property or privilege is claimed are defined as follows:

1. A windlass, for use in connection with a boat, an anchor, and a rode, the rode having a tensioned portion entering the windlass and a slack portion exiting the windlass, the windlass being adapted for selective powered raising and lowering of the anchor, the windlass comprising:
a base extending between opposite front and rear ends, and between opposite left and right sides, and between opposite top and bottom surfaces, the base having at least one aperture from the top through to the bottom, the base having a motor mounting hole from the top through to the bottom, the base bottom surface being adapted for attachment to the boat, the base having a divider plate extending between the base front and rear ends, and extending upward from the base top surface, the divider plate having a drive side and an opposite chainwheel side, the divider plate having a transverse hole therethrough;
a shaft extending between opposite drive and chainwheel ends, the shaft being mounted to the base for rotation and extending through the divider plate transverse hole, the shaft having threads on the chainwheel end;
a chainwheel mounted on the shaft for rotation therewith, the chainwheel having an outer periphery and an annular groove around the outer periphery, the chainwheel annular groove being adapted to engage the rode so as to pull the rode during rotation of the chainwheel;
a retainer extending between opposite upper and lower ends, the retainer being attached to the windlass adjacent the base front end, the retainer being flexible, the retainer being disposed across the chainwheel annular groove, for pressing the rode into the chainwheel annular groove so as to retain the rode on the chainwheel;
a cover extending between the base front and rear ends on the chainwheel side of the divider plate, the cover having inner and outer surfaces, the cover being attached to the base and covering the chainwheel, shaft chainwheel end, and retainer, the cover being adapted to cover the rode; and
drive means for rotatively driving the shaft, the drive means being attached to the shaft drive end.

2. The windlass of claim 1, further comprising:
a first arcuate member having opposite inner and outer sides, the first arcuate member inner side being mounted on the divider plate chainwheel side, the first arcuate member outer side facing away from the divider plate, the first arcuate member extending from a proximate end adjacent the base front end and top surface upward to a distal end, the first arcuate member having an arcuate first groove facing outward and extending along the first arcuate member from the proximate end to the distal end;
a second arcuate member having opposite inner and outer sides, the second arcuate member inner side being mounted on the first arcuate member outer side, the second arcuate member extending from a proximate end adjacent the base front end and top surface upward to a distal end, the second arcuate member having an arcuate second groove facing inward and extending along the second arcuate member from the proximate end to the distal end, the second groove facing and being coextensive with the first groove;
the retainer having an upper trunnion on the retainer upper end, the upper trunnion extending between opposite right and left ends, the retainer having a lower trunnion on the retainer lower end, the lower trunnion extending between opposite right and left ends, the upper and lower trunnion left ends being received in the first groove, the upper and lower trunnion right ends being received in the second groove, allowing the trunnions to pivot in the first and second grooves as the retainer flexes, and to slide in the first and second grooves toward the slack portion of the rode, so that the retainer will conform closely to the rode, especially toward the slack portion, during rotation of the chainwheel in either direction.

3. The windlass of claim 2, further comprising a leaf spring mounted coextensively on the retainer, for biasing the retainer against the rode.

4. The windlass of claim 3, further comprising:
an upper pin extending transversely through the upper trunnion and a lower pin extending transversely through the lower trunnion, to strengthen the trunnions;
the retainer having a front surface and an opposite rear surface, the retainer rear surface having corrugations for contact with the rode, so that the corrugations will cause the retainer to slide upwardly and downwardly in the first and second grooves toward the slack portion of the rode so as to preclude the slack portion of the rode from riding off the chainwheel;
the leaf spring extending between opposite upper and lower ends;
the retainer having a pocket adjacent the upper end for receiving the leaf spring upper end, the retainer having a pocket adjacent the lower end for receiving the leaf spring lower end, so as to hold the leaf spring closely adjacent the retainer front surface, while allowing the leaf spring to flex with the retainer.

5. The windlass of claim 1, wherein the drive means further comprises:
a motor mounted beneath the base and aligned with the motor mounting hole;
the base having a gearcase integral therewith, and juxtaposed with the motor mounting hole;
a worm and worm gear set mounted in the gearcase and attached to the motor; and
a spur gear set mounted between the worm gear set and the shaft drive end, so as to transmit rotary power from the motor to the shaft.

6. The windlass of claim 1; further comprising a funnel having a mouth facing upward, the funnel having a nozzle extending downward and communicating with the mouth, the funnel being mounted on the base aperture for directing the rode downward into the boat.

7. The windlass of claim 1, further comprising:
the chainwheel having a first portion and an opposite second portion, the first and second portions being joined for rotation in unison;
a first clutch disk mounted on the shaft and keyed for rotation therewith, the first clutch disk frictionally engaging the chainwheel first portion so as to transmit torque from the shaft to the chainwheel;
a second clutch disk mounted on the shaft and keyed for rotation therewith, the second clutch disk frictionally engaging the chainwheel second portion so as to transmit torque from the shaft to the chainwheel; and
a nut mounted for rotation with the shaft and threadingly engaging the shaft chainwheel end for retaining the clutch disks and chainwheel on the shaft, and for selectively adjusting the frictionally engaging of the clutch disks and the chainwheel to allow slippage of the clutch, thereby precluding breakage of the rode.

8. The windlass of claim 7, further comprising:
a sleeve disposed between the chainwheel first and second portions, the sleeve being concentric with the shaft; and
a stripper plate having a proximal end encircling the annular groove between the chainwheel first and second portions and extending rearward to a distal end attached to the base, so as to transmit pulling forces from the rode through the chainwheel, through the stripper plate to the base, thereby reducing radial forces on the shaft, and to strip the rode from engagement with the chainwheel.

9. The windlass of claim 7, further comprising a freefall mechanism, including:
the nut having a periphery and a rim around the periphery;
a stop pin mounted inside the nut for sliding motion between a retracted position within the nut rim and an extended position extending outward beyond the nut rim, so as to follow a predetermined rotational path in concert with the nut;
a spring juxtaposed with the stop pin for biasing the stop pin into the extended position;
a release button mounted inside the nut and projecting outside the nut for selectively releasing the stop pin for movement into the extended position; and
a stop block mounted on the base and disposed in the rotational path of the stop pin; so that upon powered lowering of the anchor, the release button will be activated, the stop pin will move into the extended position, the stop pin will strike the stop block, thereby causing rotation of the nut to stop, rotation of the shaft will cause the nut to move axially outward on the shaft threads, thereby releasing engagement of the clutch disks from the chainwheel, and allowing the rode to exit the windlass in freefall.

10. A windlass, for use in connection with a boat, an anchor, and a rode, the rode having a tensioned portion entering the windlass and a slack portion exiting the windlass, the windlass being adapted for selective powered raising and lowering of the anchor, the windlass comprising:
a base extending between opposite front and rear ends, and between opposite left and right sides, and between opposite top and bottom surfaces, the base having at least one aperture from the top through to the bottom, the base having a motor mounting hole from the top through to the bottom, the base bottom surface being adapted for attachment to the boat, the base having a divider plate extending between the base front and rear ends, and extending upward from the base top surface, the divider plate having a drive side and an opposite chainwheel side, the divider plate having a transverse hole therethrough;
a shaft extending between opposite drive and chainwheel ends, the shaft being mounted to the base for rotation and extending through the divider plate transverse hole, the shaft having threads on the chainwheel end;
a chainwheel mounted on the shaft for rotation therewith, the chainwheel having an outer periphery and an annular groove around the outer periphery, the chainwheel annular groove being adapted to engage the rode so as to pull the rode during rotation of the chainwheel;
a first arcuate member having opposite inner and outer sides, the first arcuate member inner side being mounted on the divider plate chainwheel side, the first arcuate member outer side facing away from the divider plate; the first arcuate member extending from a proximate end adjacent the base front end and top surface upward to a distal end, the first arcuate member having an arcuate first groove facing outward and extending along the first arcuate member from the proximate end to the distal end;
a second arcuate member having opposite inner and outer sides, the second arcuate member inner side being mounted on the first arcuate member outer side, the second arcuate member extending from a proximate end adjacent the base front end and top surface upward to a distal end, the second arcuate member having an arcuate second groove facing inward and extending along the second arcuate member from the proximate end to the distal end, the second groove facing and being coextensive with the first groove;
a retainer extending between opposite upper and lower ends, the retainer being flexible, the retainer being disposed across the chainwheel annular groove, for pressing the rode into the chainwheel annular groove so as to retain the rode on the chainwheel, the retainer having an upper trunnion on the retainer upper end, the upper trunnion extending between opposite right and left ends, the retainer having a lower trunnion on the retainer lower end, the lower trunnion extending between opposite right and left ends, the upper and lower trunnion left ends being received in the first groove, the upper and lower trunnion right ends being received in the second groove, allowing the trunnions to pivot in the first and second grooves as the retainer flexes, and to slide in the first and second grooves toward, the slack portion of the rode, so that the retainer will conform closely to the rode, especially toward the slack portion, during rotation of the chainwheel in either direction;
a leaf spring mounted coextensively on the retainer, for biasing the retainer against the rode;
a cover extending between the base front and rear ends on the chainwheel side of the divider plate, the cover having inner and outer surfaces, the cover being attached to the base and covering the chainwheel, shaft chainwheel end, and retainer, the cover being adapted to cover the rode; and
drive means for rotatively driving the shaft, the drive means being attached to the shaft drive end.

11. The windlass of claim 10, further comprising:
an upper pin extending transversely through the upper trunnion and a lower pin extending transversely through the lower trunnion, to strengthen the trunnions;
the retainer having a front surface and an opposite rear surface, the retainer rear surface having corrugations for contact with the rode, so that the corrugations will cause the retainer to slide upwardly and downwardly in the first and second grooves toward the slack portion of the rode so as to preclude the slack portion of the rode from riding off the chainwheel;
the leaf spring extending between opposite upper and lower ends; and
the retainer having a pocket adjacent the upper end for receiving the leaf spring upper end, the retainer having a pocket adjacent the lower end for receiving the leaf spring lower end, so as to hold the leaf spring closely adjacent the retainer front surface, while allowing the leaf spring to flex with the retainer.

12. The windlass of claim 10, wherein the drive means further comprises:
a motor mounted beneath the base and aligned with the motor mounting hole;
the base having a gearcase integral therewith, and juxtaposed with the motor mounting hole;
a worm and worm gear set mounted in the gearcase and attached to the motor; and
a spur gear set mounted between the worm gear set and the shaft drive end, so as to transmit rotary power from the motor to the shaft.

13. The windlass of claim 10, further comprising a funnel having a mouth facing upward, the funnel having a nozzle extending downward and communicating with the mouth, the funnel being mounted on the base aperture for directing the rode downward into the boat.

14. The windlass of claim 10, further comprising:
the chainwheel having a first portion and an opposite second portion, the first and second portions being joined for rotation in unison;
a first clutch disk mounted on the shaft and keyed for rotation therewith, the first clutch disk frictionally engaging the chainwheel first portion so as to transmit torque from the shaft to the chainwheel;
a second clutch disk mounted on the shaft and keyed for rotation therewith, the second clutch disk frictionally engaging the chainwheel second portion so as to transmit torque from the shaft to the chainwheel; and
a nut mounted for rotation with the shaft and threadingly engaging the shaft chainwheel end for retaining the clutch disks and chainwheel on the shaft, and for selectively adjusting the frictionally engaging of the clutch disks and the chainwheel to allow slippage of the clutch, thereby precluding breakage of the rode.

15. The windlass of claim 14, further comprising:
a sleeve disposed between the chainwheel first and second portions, the sleeve being concentric with the shaft; and
a stripper plate having a proximal end encircling the annular groove between the chainwheel first and second portions and extending rearward to a distal end attached to the base, so as to transmit pulling forces from the rode through the chainwheel, through the stripper plate to the base, thereby reducing radial forces on the shaft, and to strip the rode from engagement with the chainwheel.

16. The windlass of claim 15, further comprising a freefall mechanism, including:
the nut having a periphery and a rim around the periphery;
a stop pin mounted inside the nut for sliding motion between a retracted position within the nut rim and an extended position extending outward beyond the nut rim, so as to follow a predetermined rotational path in concert with the nut;
a spring juxtaposed with the stop pin for biasing the stop pin into the extended position;
a release button mounted inside the nut and projecting outside the nut for selectively releasing the stop pin for movement into the extended position; and
a stop block mounted on the base and disposed in the rotational path of the stop pin; so that
upon powered lowering of the anchor, the release button will be activated, the stop pin will move into the extended position, the stop pin will strike the stop block, thereby causing rotation of the nut to stop, rotation of the shaft will cause the nut to move axially outward on the shaft threads, thereby releasing engagement of the clutch disks from the chainwheel, and allowing the rode to exit the windlass in freefall.

17. A windlass, for use in connection with a boat, an anchor, and a rode, the rode having a tensioned portion entering the windlass and a slack portion exiting the windlass, the windlass being adapted for selective powered raising and lowering of the anchor, the windlass comprising:
a base extending between opposite front and rear ends, and between opposite left and right sides, and between opposite top and bottom surfaces, the base having at least one aperture from the top through to the bottom, the base having a motor mounting hole from the top through to the bottom, the base bottom surface being adapted for attachment to the boat, the base having a divider plate extending between the base front and rear ends, and extending upward from the base top surface, the divider plate having a drive side and an opposite chainwheel side, the divider plate having a transverse hole therethrough;
a shaft extending between opposite drive and chainwheel ends, the shaft being mounted to the base for rotation and extending through the divider plate transverse hole, the shaft having threads on the chainwheel end;
a chainwheel mounted on the shaft for rotation therewith, the chainwheel having an outer periphery and an annular groove around the outer periphery, the chainwheel annular groove being adapted to engage the rode so as to pull the rode during rotation of the chainwheel;
a first arcuate member having opposite inner and outer sides, the first arcuate member inner side being mounted on the divider plate chainwheel side, the first arcuate member outer side facing away from the divider plate, the first arcuate member extending from a proximate end adjacent the base front end and top surface upward to a distal end, the first arcuate member having an arcuate first groove facing outward and extending along the first arcuate member from the proximate end to the distal end;
a second arcuate member having opposite inner and outer sides, the second arcuate member inner side being mounted on the first arcuate member outer side, the second arcuate member extending from a proximate end adjacent the base front end and top surface upward to a distal end, the second arcuate member having an arcuate second groove facing inward and extending along the second arcuate member from the proximate end to the distal end, the second groove facing and being coextensive with the first groove;
a retainer extending between opposite upper and lower ends, the retainer having an upper pocket adjacent the upper end and a lower pocket adjacent the lower end, the retainer being flexible, the retainer being disposed across the chainwheel annular groove, for pressing the rode into the chainwheel annular groove so as to retain the rode on the chainwheel, the retainer having an upper trunnion on the retainer upper end, the upper trunnion extending between opposite right and left ends, the retainer having a lower trunnion on the retainer lower end, the lower trunnion extending between opposite right and left ends, an upper pin extending transversely through the upper trunnion and a lower pin extending transversely through the lower trunnion to strengthen the trunnions, the upper and lower trunnion left ends being received in the first groove, the upper and lower trunnion right ends being received in the second groove, allowing the trunnions to pivot in the first and second grooves as the retainer flexes, and to slide in the first and second grooves toward the slack portion of the rode, so that the retainer will conform closely to the rode, especially toward the slack portion, during rotation of the chainwheel in either direction, the retainer having a front surface and an opposite rear surface, the retainer rear surface having corrugations for contact with the rode, so that the corrugations will cause the retainer to slide upwardly and downwardly in the first and second grooves toward the slack portion of the rode so as to preclude the slack portion of the rode from riding off the chainwheel;
a leaf spring extending between opposite upper and lower ends, the leaf spring being mounted coextensively on the retainer, for biasing the retainer against the rode, the leaf spring upper end being received in the upper pocket, the leaf spring lower end being received in the lower pocket, so as to hold the leaf spring closely adjacent the retainer front surface, while allowing the leaf spring to flex with the retainer;
a cover extending between the base front and rear ends on the chainwheel side of the divider plate, the cover having inner and outer surfaces, the cover being attached to the base and covering the chainwheel, shaft chainwheel end, and retainer, the cover being adapted to cover the rode; and
drive means for rotatively driving the shaft, the drive means being attached to the shaft drive end.

18. The windlass of claim 17, wherein the drive means further comprises:
a motor mounted beneath the base and aligned with the motor mounting hole;
the base having a gearcase integral therewith, and juxtaposed with the motor mounting hole;
a worm and worm gear set mounted in the gearcase and attached to the motor; and
a spur gear set mounted between the worm gear set and the shaft drive end, so as to transmit rotary power from the motor to the shaft.

19. The windlass of claim 17, further comprising:
a funnel having a mouth facing upward, the funnel having a nozzle extending downward and communicating with the mouth, the funnel being mounted on the base aperture for directing the rode downward into the boat;
the chainwheel having a first portion and an opposite second portion, the first and second portions being joined for rotation in unison, a sleeve being disposed between the chainwheel first and second portions, the sleeve being concentric with the shaft;
a first clutch disk mounted on the shaft and keyed for rotation therewith, the first clutch disk frictionally engaging the chainwheel first portion so as to transmit torque from the shaft to the chainwheel;
a second clutch disk mounted on the shaft and keyed for rotation therewith, the second clutch disk frictionally engaging the chainwheel second portion so as to transmit torque from the shaft to the chainwheel;
a nut mounted for rotation with the shaft and threadingly engaging the shaft chainwheel end for retaining the clutch disks and chainwheel on the shaft, and for selectively adjusting the frictionally engaging of the clutch disks and the chainwheel to allow slippage of the clutch, thereby precluding breakage of the rode; and
a stripper plate having a proximal end encircling the annular groove between the chainwheel first and second portions and extending rearward to a distal end attached to the base, so as to transmit pulling forces from the rode through the chainwheel, through the stripper plate to the base, thereby reducing radial forces on the shaft, and to strip the rode from engagement with the chainwheel.

20. The windlass of claim 17, further comprising a freefall mechanism, including:
the nut having a periphery and a rim around the periphery;
a stop pin mounted inside the nut for sliding motion between a retracted position within the nut rim and an extended position extending outward beyond the nut rim, so as to follow a predetermined rotational path in concert with the nut;
a spring juxtaposed with the stop pin for biasing the stop pin into the extended position;
a release button mounted inside the nut and projecting outside the nut for selectively releasing the stop pin for movement into the extended position; and
a stop block mounted on the base and disposed in the rotational path of the stop pin; so that upon powered lowering of the anchor, the release button will be activated, the stop pin will move into the extended position, the stop pin will strike the stop block, thereby causing rotation of the nut to stop, rotation of the shaft will cause the nut to move axially outward on the shaft threads, thereby releasing engagement of the clutch disks from the chainwheel, and allowing the rode to exit the windlass in freefall.
